(19) United States
(12) Patent Application Publication
(10) Pub. No.: US 2007/0257616 A1
(43) Pub. Date: Nov. 8, 2007

(54) Plasma display panel

(76) Inventor: Ho-Seok Lee, Suwon-si (KR)

Correspondence Address: Robert E. Bushnell, Suite 300, 1522 K Street, N.W., Washington, DC, 20005, US

(21) Appl. No.: 11/797,892

(22) Filed: May 8, 2007

(30) Foreign Application Priority Data
May 8, 2006 (KR) 10-2006-0041099

(51) Int. Cl. H01J 17/49

(52) U.S. Cl. 313/582; 313/586

(57) ABSTRACT

A plasma display panel design with improved discharge efficiency. The plasma display panel includes a front substrate, a rear substrate that faces the front substrate, a plurality of barrier ribs adapted to partition a space between the front substrate and the rear substrate and define a plurality of discharge cells, a plurality of display electrodes arranged to correspond to the plurality of discharge cells, a dielectric layer that covers the plurality of discharge electrodes and a plurality of address electrodes extending in a direction that crosses the plurality of display electrodes and the plurality of discharge cells, wherein a recess portion is arranged on side surfaces of ones of the plurality of barrier ribs. Empirically, it is shown that the luminescence efficiency is improved with a recess portion formed on the barrier rib.

This application makes reference to, incorporates the same herein, and claims all benefits accruing under 35 U.S.C. § 119 from an application for PLASMA DISPLAY PANEL earlier filed in the Korean Intellectual Property Office on 8 May 2006 and there duly assigned Serial No. 10-2006-0041099.

### BACKGROUND OF THE INVENTION

1. Field of the Invention

The present invention relates to a plasma display panel (PDP) having an improved discharge cell structure that enhances discharge efficiency.

2. Description of the Related Art

A PDP is a display element that realizes an image using visible light generated by exciting phosphors with vacuum ultraviolet (UV) light radiated by plasma obtained by the discharge of gas. Such a PDP can realize an extra-large screen of over 60 inches, thus the PDP has been spotlighted as a next-generation industrial flat panel display.

The most common structure for the PDP is a three-electrode surface discharge structure. The three-electrode surface discharge PDP includes a front substrate, a pair of discharge electrodes arranged thereon and facing each other, and a rear substrate arranged apart from the front substrate and having address electrodes arranged thereon. Between the front substrate and the rear substrate are a plurality of discharge cells that are defined by a plurality of barrier ribs. The discharge cells are formed in an area where the pair of discharge electrodes and the address electrodes intersect each other. A phosphor layer is formed within the discharge cells and the discharge cells are filled with a discharge gas.

More than millions of unit discharge cells are arranged in matrix within the PDP that is formed in the above-described way. Discharge cells to be turned on or turned off are chosen using memory characteristics of wall charges. The selected discharge cells are discharged to display images.

Vacuum ultraviolet rays generated from a discharge gas excite the phosphor and images are displayed by radiating visible light of respective colors. Therefore, phosphor layers formed along respective discharge cells bear a close relationship with display capacity and discharge efficiency of the PDP.

As the resolution of the PDP becomes higher, the size of the discharge cells becomes smaller. When the discharge spaces become smaller, the area of phosphor that is provided for discharge cells diminishes causing discharge efficiency to lower. Therefore, what is needed is an improved design for a PDP that increases the area that phosphor can be deposited on within the discharge cells so that discharge efficiency can be improved, even when the discharge spaces are small.

### SUMMARY OF THE INVENTION

The embodiments of the present invention provide a plasma display panel that is capable of enhancing discharge efficiency by improving a structure of a discharge cell.

According to one aspect of the present invention, there is provided a plasma display panel that includes a front substrate, a rear substrate that faces the front substrate, a plurality of barrier ribs adapted to partition a space between the front substrate and the rear substrate and define a plurality of discharge cells, a plurality of display electrodes arranged to correspond to each of the plurality of discharge cells, a dielectric layer that covers the plurality of discharge electrodes and a plurality of address electrodes extending in a direction that crosses the plurality of display electrodes and the plurality of discharge cells, wherein a recess portion is arranged on side surfaces of the plurality of barrier ribs.

Ones of the plurality of barrier ribs can include a top surface that faces the front substrate, wherein a distance between the top surface one of said plurality of barrier ribs and a center of the recess portion is the same as a width of the top surface. A depth of the recess portion can be measured from an extension line that extends from an edge of the top surface and is perpendicular to the rear substrate, and the depth is ⅕ the width of the top surface of ones of the plurality of barrier ribs. A depth of the recess portion can be measured from an extension line that extends from an edge of the top surface and is perpendicular to the rear substrate, and the depth is smaller than ⅕ a width of the top surface of ones of the plurality of barrier ribs. Ones of the plurality of barrier ribs can further include a bottom surface that faces the rear substrate, wherein the top surface is wider than the bottom surface. the recess portion can be arranged closer to the top surface than the bottom surface. A distance between the top surface and a center of the recess portion can be smaller than a width of the top surface. A depth of the recess portion is measured from an extension line that extends from the edge of the top surface and is perpendicular to the rear substrate, and the depth can be ⅕ a width of the top surface of the barrier ribs. The depth can be smaller than ⅕ the width of the top surface of the barrier ribs. The top surface can be narrower than the bottom surface. The recess portion can be arranged closer to the top surface than to the bottom surface. A lateral cross-section of the recess portion can be in the shape of an arc. Each of the plurality of barrier ribs can include an inclined surface that extends from the recess portion towards the rear substrate. Each of the plurality of display electrodes can include a first linear portion that is in the shape of a stripe and faces each other to form a discharge gap and a second linear portion that is in the shape of a stripe and arranged apart from the first linear portion. Each of the plurality of display electrodes can also include a third linear portion that is arranged between the first linear portion and the second linear portion, wherein the third linear portion is arranged apart both from the first linear portion and the second linear portion.

According to another aspect of the present invention, there is provided a PDP that includes a front substrate, a rear substrate that faces the front substrate, a plurality of barrier ribs partitioning a space between the front substrate and the rear substrate into a plurality of discharge cells, wherein sidewalls of ones of the plurality of barrier ribs include a recess, a plurality of address electrodes arranged on the rear substrate and adapted to select ones of the plurality of discharge cells for discharge, a plurality of display electrodes arranged on the front substrate and extending in a direction orthogonal to the plurality of address electrodes and adapted to produce a sustain discharge within said selected ones of the plurality of discharge cells, a dielectric layer arranged on the address electrodes and on the rear substrate and a plurality of phosphor layers arranged on the dielectric layer and on sidewalls of ones of the plurality of barrier ribs.

The recess can be adapted to provide a greater surface area within each of said plurality of discharge cells onto which the plurality of phosphor layers can be arranged. The sidewalls of the plurality of barrier ribs can also include an inclined surface extending from said recess to a bottom surface that faces the rear substrate. The plurality of display electrodes can also include a plurality of linear portions that are stripe-shaped and are parallel to each other and are spaced apart from each other.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a partial perspective view for a plasma display panel according to an embodiment of the present invention;

FIG. 2 is a top plan view showing the structural relationship between discharge electrodes and discharge cells of the PDP in FIG. 1;

FIG. 3 is a top plan view showing discharge electrodes including metallic line portions according to another embodiment of the present invention;

FIG. 4 is a cross-sectional view along the line IV-IV in FIG. 2; and

FIG. 5 is a photograph showing a lateral cross-section of a barrier rib formed according to the present invention.

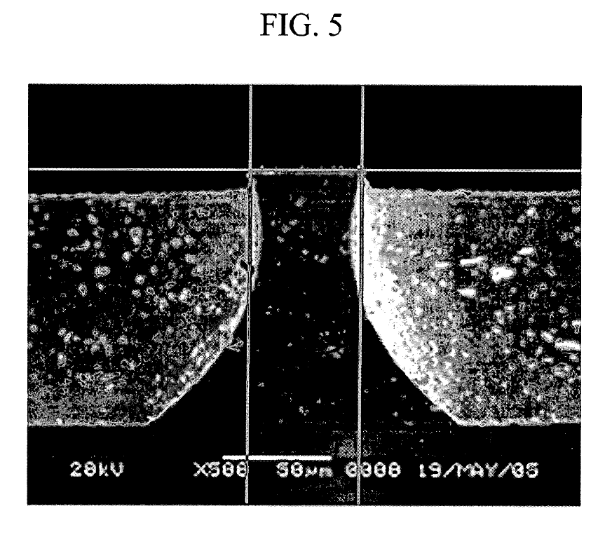

### DETAILED DESCRIPTION OF THE INVENTION

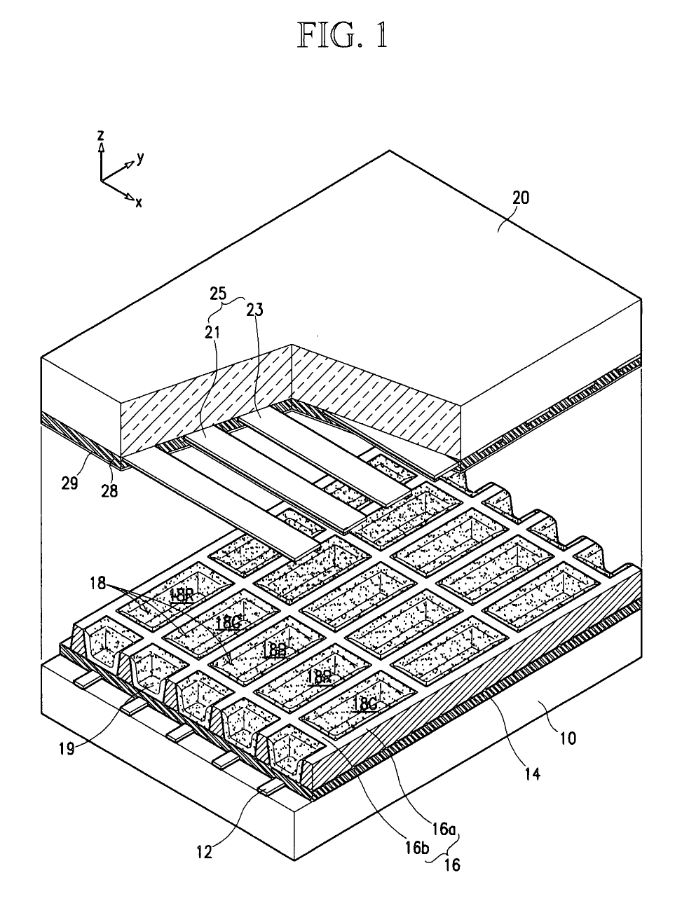

Referring now to FIG. 1, the plasma display panel (PDP) of an embodiment of the present invention includes a front substrate 20 and a rear substrate 10 facing each other. A space between the front substrate 20 and the rear substrate 10 is partitioned by barrier ribs 16 to form a plurality of discharge cells 18. The discharge cells 18 include a sub-pixels that are the smallest unit displaying an image, and a plurality of sub-pixels form a pixel. Display electrodes 25 and address electrodes 12 are formed to correspond to each discharge cell 18. The display electrodes 25 and the address electrode 12 intersect within the discharge cell 18.

The front substrate 20 is made of transparent material such as reinforced glass. An image generated by a discharge in the discharge cell is displayed through the front substrate 20.

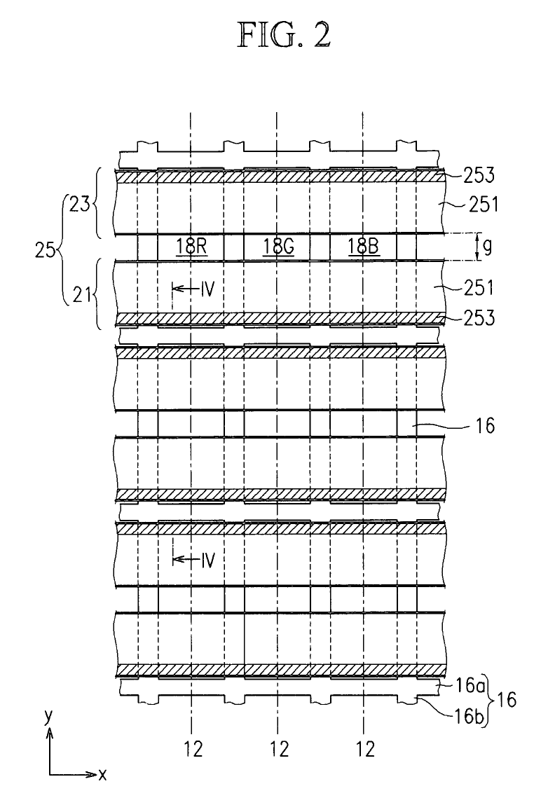

The display electrodes 25 are formed on the front substrate 20. The display electrodes 25 correspond to each discharge cell 18. The display electrodes 25 can include first electrodes (hereinafter “scan electrodes” 21) and second electrodes (hereinafter “sustain electrodes” 23). The scan electrodes 21 and the sustain electrodes 23 can face each other and form a discharge gap g (refer to FIG. 2).

The scan electrode 21 interacts with the address electrode 12 and selects a discharge cell to be turned on. The sustain electrode 23 interacts with the scan electrodes 23 and causes sustain discharge within selected discharge cells 18.

The display electrodes 25 are covered with a dielectric layer 28 made of a dielectric material (for example PbO, B₂O₃, or SiO₂). The dielectric layer 28 prevents electrically charged particles from colliding with and damaging the display electrodes 25 during discharge. The dielectric layer 28 can be covered with a protective layer 29 (for example MgO). The protective layer 29 prevents electrically charged particles from colliding with and damaging the dielectric layer 28. In addition, the protective layer 29 improves discharge efficiency by emitting secondary electrons upon collision with electrically charged particles.

The address electrodes 12 are formed on a surface of the rear substrate 10 that faces the front substrate 20. The address electrodes 12 intersect the display electrodes 25 and extend along a direction (y-axis direction) corresponding to each discharge cell 18. The address electrodes 12 can be formed in stripe patterns on the rear substrate 10. The address electrodes 12 interact with the scan electrodes 21 to select discharge cells 18 to be turned on. The address electrodes 12 are covered with and protected by a dielectric layer 14. The barrier ribs 16 are formed on the dielectric layer 14.

The barrier ribs 16 protrude from the rear substrate 10 toward the front substrate 20 in predetermined patterns (for example, a stripe pattern, a matrix pattern, a delta pattern, etc.) and partition the space between the rear substrate 10 and the front substrate 20. In the present embodiment, the barrier ribs 16 in a matrix pattern are exemplified.

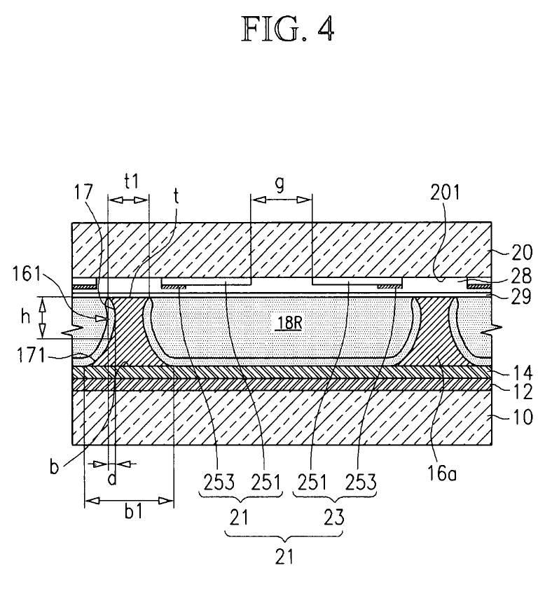

A recess portion 17 is formed on a side surface 161 (refer to FIG. 4) of the barrier ribs 16. The lateral cross-section of the recess portion 17 is in the shape of an arc. The recess portion 17 expands the area of the phosphor that is distributed over the side surface 161 of the barrier rib 16.

A phosphor layer 19 that radiates visible light of each color is formed within the discharge cells 18. The respective phosphor layers 19 of red (R), green (G), and blue (B) are formed within the respective discharge cells 18. Red (18R), green (18G), and blue (18B) discharge cells form a pixel. Each discharge cell 18 is filled with a mixed discharge gas of neon (Ne) or Xenon (Xe).

Referring now to FIG. 2, the barrier ribs 16 includes horizontal barrier ribs 16a and vertical barrier ribs 16b. The horizontal barrier ribs 16a extend in a first direction (x-axis direction in the drawings) and the vertical barrier ribs 16b extend along a second direction (y-axis direction in the drawings). In other words, the horizontal barrier ribs 16a are formed in a direction crossing the address electrodes 12, and the vertical barrier ribs 16b are formed in a direction parallel to the address electrodes 12.

The discharge cells 18 are partitioned in a matrix pattern by the barrier ribs 16. Thus, discharge cells of different colors are arranged sequentially in the first direction, and discharge cells of the same colors are arranged in the second direction.

The scan electrodes 21 and the sustain electrodes 23 that form display electrodes 25 extend in the first direction, and face each other and form a discharge gap g in the second direction. In addition, the scan electrodes 21 and the sustain electrodes 23 can include transparent electrodes 251 that are formed in the shape of a thin film on an inner surface 201 of the front substrate 20 that faces the rear substrate 10. Metal electrodes 253 can be formed on the transparent electrodes 251. In this case, the display electrodes 25 are arranged over the discharge cells 18 (refer to FIG. 4).

Alternatively, the display electrodes 45 can include a plurality of linear portions that are each in the shape of stripes and arranged with a certain distance therebetween. In this case, the linear portions are made of a highly conductive and opaque metal such as silver (Ag) or copper (Cu).

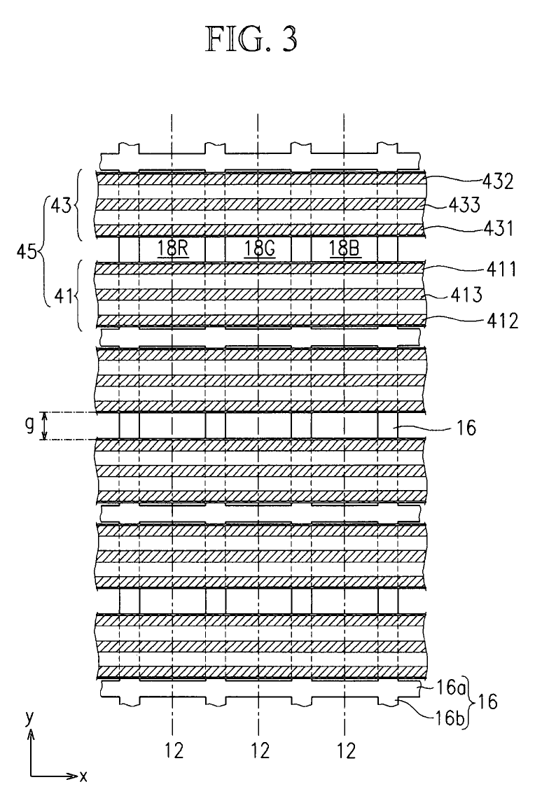

Referring now to FIG.3, a scan electrode 41 and a sustain electrode 43 respectively include first linear portions 411 and 431 and second linear portions 412 and 432. The first linear portions 411 and 431 extend in the first direction and face each other to form a discharge gap g in the second direction. The second linear portions 412 and 432 also extend in the first direction and are arranged at a certain distance from the first linear portions 411 and 431. In one embodiment, there is no electrode between the first linear portions 411 and 431 and the second linear portions 412 and 432, so that the aperture ratio of the discharge cell 18 can be improved. In an alternate embodiment, third liner portions 413 and 433 can be formed between the first linear portions 411 and 431 and the second linear portions 412 and 432, and can be apart from the first and second linear portions 411, 431, 412, and 432.

Referring now to FIG.4, the barrier ribs 16 stand straight from the rear substrate 10 toward the front substrate 20. The bottom surface b and the top surface t of each barrier rib 16 face the rear substrate 10 and the front substrate 20, respectively. The bottom surface b is in contact with the dielectric layer 14 that protects the address electrodes 12, and the top surface t is in contact with the protective layer 29.

The width t1 of the top surface t of the barrier rib 16 is formed to be narrower than the width b1 of the bottom surface b to establish a stable structure. Therefore, the barrier rib 16 can have a stable structure even though the recess portion 17 is formed on the side surface 161.

The recess portion 17 is formed inwardly from the side surface 161 of the barrier rib 16. The lateral cross-section of the recess portion 17 can be formed in the shape of an arc.

The recess portion 17 is formed to be closer to the top surface t than to the bottom surface b of the barrier rib 16. An inclined portion 171 is formed to extend from the recess portion 17 toward the rear substrate 10. The shape of the inclined portion 171 is not limited to a straight line.

A distance h between the top surface t and the center of the recess portion 17 is the same as or smaller than the width t1 of the top surface t. That is, the following Formula 1 can be applied to the recess portion 17.
h≦t1 (Formula 1)

If the distance h between the top surface t of the barrier rib 16 and the center of the recess portion 17 is greater than the width t1 of the top surface t, the barrier rib 16 becomes too thin so that it breaks or collapses.

The depth d of the recess portion 7 is measured from an extension line that extends from the edge of the top surface t and is perpendicular (i.e., normal) to the rear substrate, and the depth d is the same as or smaller than ⅕ the width t1 of the top surface t of the barrier rib 16. That is, the following Formula 2 can be applied to the recess portion 17.
d≦0.2*t1 (Formula 2)

If the depth d of the recess portion 17 is deeper than defined in Formula 2, cracks can appear in the barrier rib 16 and further the barrier rib 16 can collapse.

When the recess portion 17 is formed according to Formulas 1 and 2, stability of the process can be ensured while efficiency of luminescence of the discharge cell can be maximized as shown in the following experimental examples:

### EXAMPLES

Table 1 shows results of different luminescences measured in a 42-inch SD class PDP between an experimental example and a comparative example. The experimental example has a recess portion formed on the barrier rib and the comparative example has no recess portion.

The experimental example and the comparative example are manufactured to be the same except for the recess portion. The experiment was carried out with four different signal intensities. The results of the experiment as recorded in Table 1 show that luminescence in the experimental example that has a recess portion was relatively higher. One of the reasons for this result is that the recess within the sidewalls of the barrier ribs allows more phosphors to be formed within the discharge cells due to surface tension by the recess portion.

TABLE 1

| | Comparative Example | Experimental Example |
|---|---|---|
| Signal Intensity | (without recess) | (with recess) |
| A | 1104 | 1218 |
| B | 675 | 734 |
| C | 310 | 345 |
| D | 84 | 93 |

Although certain exemplary embodiments of the present invention have been shown and described, the present invention is not limited to the described embodiments, but can be modified in various forms without departing from the scope of the invention set forth in the detailed description, the accompanying drawings, the appended claims, and their equivalents.

What is claimed is:

1. A plasma display panel (PDP), comprising:
a front substrate;
a rear substrate that faces the front substrate;
a plurality of barrier ribs adapted to partition a space between the front substrate and the rear substrate and define a plurality of discharge cells;
a plurality of display electrodes arranged to correspond to the plurality of discharge cells;
a dielectric layer that covers the plurality of discharge electrodes; and
a plurality of address electrodes extending in a direction that crosses the plurality of display electrodes and the plurality of discharge cells, wherein a recess portion is arranged on side surfaces of ones of the plurality of barrier ribs.

2. The PDP of claim 1, wherein ones of the plurality of barrier ribs include a top surface that faces the front substrate, wherein a distance between the top surface one of said plurality of barrier ribs and a center of the recess portion is the same as that of a width of the top surface.

3. The PDP of claim 2, wherein a depth of the recess portion is measured from an extension line that extends from an edge of the top surface and is perpendicular to the rear substrate, and the depth is ⅕ the width of the top surface of ones of the plurality of barrier ribs.

4. The PDP of claim 2, wherein a depth of the recess portion is measured from an extension line that extends from an edge of the top surface and is perpendicular to the rear substrate, and the depth is smaller than ⅕ a width of the top surface of ones of the plurality of barrier ribs.

5. The PDP of claim 4, wherein ones of the plurality of barrier ribs further include a bottom surface that faces the rear substrate, wherein the bottom surface is wider than the top surface.

6. The PDP of claim 5, wherein the recess portion is arranged closer to the top surface than the bottom surface.

7. The PDP of claim 1, wherein ones of the plurality of barrier ribs include a top surface that faces the front substrate, wherein a distance between the top surface of one of said plurality of barrier ribs and a center of the recess portion is smaller than a width of the top surface.

8. The PDP of claim 7, wherein a depth of the recess portion is measured from an extension line that extends from the edge of the top surface and is perpendicular to the rear substrate, and the depth is ⅕ the width of the top surface of ones of the plurality of barrier ribs.

9. The PDP of claim 7, wherein a depth of the recess portion is measured from an extension line that extends from an edge of the top surface and is perpendicular to the rear substrate, and the depth is smaller than ⅕ the width of the top surface of ones of the plurality of barrier ribs.

10. The PDP of claim 9, wherein ones of the plurality of barrier ribs include a bottom surface that faces the rear substrate, the top surface being narrower than the bottom surface.

11. The PDP of claim 10, wherein the recess portion is arranged closer to the top surface than to the bottom surface.

12. The PDP of claim 1, wherein a lateral cross-section of the recess portion is in the shape of an arc.

13. The PDP of claim 12, wherein each of the plurality of barrier ribs include an inclined surface that extends from the recess portion towards the rear substrate.

14. The PDP of claim 1, wherein each of the plurality of display electrodes comprise:
a first linear portion that is in the shape of a stripe and faces each other to form a discharge gap; and
a second linear portion that is in the shape of a stripe and arranged apart from the first linear portion.

15. The PDP of claim 14, wherein each of the plurality of display electrodes further comprise a third linear portion that is arranged between the first linear portion and the second linear portion, wherein the third linear portion is arranged apart both from the first linear portion and the second linear portion.

16. A plasma display panel (PDP), comprising:
a front substrate;
a rear substrate that faces the front substrate;
a plurality of barrier ribs partitioning a space between the front substrate and the rear substrate into a plurality of discharge cells, wherein sidewalls of ones of the plurality of barrier ribs include a recess arranged therein;
a plurality of address electrodes arranged on the rear substrate and adapted to select ones of the plurality of discharge cells for discharge;
a plurality of display electrodes arranged on the front substrate and extending in a direction orthogonal to the plurality of address electrodes and adapted to produce a sustain discharge within said selected ones of the plurality of discharge cells;
a dielectric layer arranged on the address electrodes and on the rear substrate; and
a plurality of phosphor layers arranged on the dielectric layer and on sidewalls of ones of the plurality of barrier ribs.

17. The PDP of claim 16, the recess being adapted to provide a greater surface area within each of said plurality of discharge cells onto which the plurality of phosphor layers can be arranged.

18. The PDP of claim 16, the sidewalls of the plurality of barrier ribs further comprise an inclined surface extending from said recess to a bottom surface that faces the rear substrate.

19. The PDP of claim 16, each of the plurality of display electrodes include a plurality of linear portions that are stripe-shaped and are parallel to each other and are spaced apart from each other.
